(19) United States
(12) Patent Application Publication
(10) Pub. No.: US 2026/0055219 A1
(43) Pub. Date: Feb. 26, 2026

(54) ULTRA-LOW LOSS HYDROCARBON RESIN COMPOSITION

(71) Applicant: HUNTSMAN ADVANCED MATERIALS (SWITZERLAND) GMBH, Basel (CH)

(72) Inventors: Christof STORZ, Basel (CH); Susanne ELMER, Basel (CH); Michael Yin WONG, Basel (CH); Kenneth Black SCOBBIE, Basel (CH); Alessandro NAPOLI, Basel (CH)

(21) Appl. No.: 19/104,243

(22) PCT Filed: Aug. 18, 2023
(86) PCT No.: PCT/EP2023/072795

§ 371 Date: Feb. 17, 2025

(30) Foreign Application Priority Data
Aug. 26, 2022 (EP) 22192483.0
Apr. 12, 2023 (WO) PCT/EP2023/059577

(51) Int. Cl. C08F 212/14; C08G 61/02; C08J 5/24

(52) U.S. Cl. CPC C08F 212/18; C08G 61/02; C08J 5/244; C08G 2261/224

(57) ABSTRACT

Ultra-low loss curable hydrocarbon resin compositions comprising vinylbenzyl compounds, a method for the preparation thereof and their use for the manufacture of articles which find application in the electric/electronic industries.

The present invention relates to vinylbenzyl-based resin compositions, to their process of manufacturing and to their uses in various applications, such as in the production of a prepreg, a laminated board for printed wiring board, a molding material and an adhesive.

The invention relates to a resin composition which provides a cured product having high heat resistance, low water absorption and excellent dielectric properties. Such advantageous properties are required for organic insulating materials for use in electronic equipment such as communication equipment.

### PRIOR ART

With the development of wireless network and satellite communications, electronic products are trending toward the need for higher speed, higher frequency and larger capacity for the transmission of voice, video and data. In addition, as these electronic products become thinner and smaller, electrical circuit boards tend to increase in complexity, density and multi-layer stratification. In order to maintain the high rate of transmission and signal integrity, printed circuit boards (“PCB”) have a need for materials with a low dielectric loss (also called loss factor or dissipation factor, Df) thereby resulting in lower signal loss.

Polymer insulating materials are usually used as substrate materials for PCBs. The laminate for the PCB is either made of the polymer insulating material alone or is obtained by blending the polymer insulating material with glass, fiber, nonwoven fabric, inorganic filler or the like. Epoxy resins have traditionally been employed due to their low cost and high heat and chemical resistance properties when cured. However, because of their relatively high dielectric constant and high dielectric loss tangent, it is difficult to achieve a suitable low dissipation factor at high frequency signals. Polyphenylene ether (PPO) resins have also been used in laminates due to their lower dielectric constants and dissipation properties, but the use of high frequency signals in new electronic fields require even lower dielectric loss constants and dissipation factors. Fluoro resins, typically represented by polytetrafluoroethylene (PTFE), have low dielectric constants and dissipation factors, but they are thermoplastic resins and therefore undergo large expansion and shrinkage during molding and processing and are materials that are not easily handled.

Other types of resins are known but cannot reach a low dielectric loss value Df, which is needed in view of the demands in the high frequency signal transmissions.

There is a need to provide a curable polyvinyl benzyl compound with improved properties, in particular in terms of Df, thermomechanical properties, humidity resistance, and which can be easily processable. There is a need to improve high speed signal transmission, whilst reducing power and interference problems in electronic applications. This requires a material composition with improved dielectric properties, while guaranteeing thermomechanical properties and easy manufacturing required for high volume sustainable production of printed circuit boards and antennas.

US2005/176909 discloses a curable polyvinyl benzyl compound obtained by reacting a fluorene compound with a vinylbenzyl halide and a dihalomethyl compound. However, the compositions disclosed are not entirely satisfactory.

There remained the need for a resin composition capable to be used in electronic equipments and providing a higher dissipation factor, and/or a higher first G′ onset and/or a higher decomposition temperature.

It is an object of the present invention to overcome the aforementioned drawbacks of the prior art resin compositions.

### SUMMARY OF THE INVENTION

A first object of the present invention is a curable resin composition obtainable, or obtained, by a method comprising at least the steps of:
(i) mixing at least the following compounds (a), (b), and (c), and
(ii) reacting said compounds in the presence of an alkali:
(a) one or more indene compound represented by the following general formula 1:

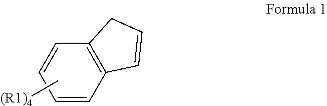

wherein each R1 is independently selected from a hydrogen atom, a halogen atom, an alkyl group having 1 to 5 carbon atoms, an alkoxy group having 1 to 5 carbon atoms, a thioalkoxy group having 1 to 5 carbon atoms, a thioaryloxy group having 6 to 14 carbon atoms, and an aryl group having 6 to 14 carbon atoms, and combinations thereof,
(b) one or more biphenyl compound represented by the following general formula 2,

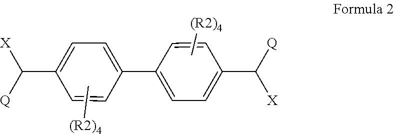

Wherein
Each X is independently selected from a halogen atom, a tosylate, a mesylate, a triflate and combinations thereof,
Each Q is independently selected from a hydrogen atom and a linear or branched C1-C6 alkyl group, and combinations thereof,
and
Each R2 is independently selected from a hydrogen atom, a linear or branched C1-C6 alkyl group, a halogen atom, and combinations thereof,
(c) one or more vinylbenzyl compound represented by the following general Formula 3:

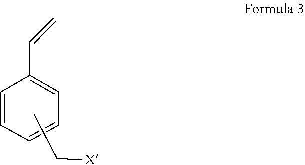

Wherein
X′ is selected from a halogen atom, a tosylate, a mesylate, a triflate and combinations thereof.

The above recited method is also an object of the invention.

Another object of the invention is a curable resin composition comprising at least
(1) A compound having the following formula C1:

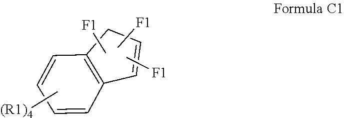

wherein each R1 is independently selected from a hydrogen atom, a halogen atom, an alkyl group having 1 to 5 carbon atoms, an alkoxy group having 1 to 5 carbon atoms, a thioalkoxy group having 1 to 5 carbon atoms, a thioaryloxy group having 6 to 14 carbon atoms, and an aryl group having 6 to 14 carbon atoms, and combinations thereof, and
each F1 is independently selected from a hydrogen atom and a vinylbenzyl group, and combinations thereof, provided that at least one of F1 is a vinylbenzyl group:

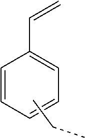

(2) A compound having the following formula C2:

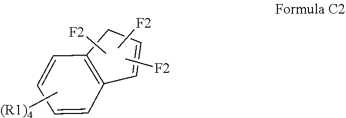

Wherein each R1 is independently selected from a hydrogen atom, a halogen atom, an alkyl group having 1 to 5 carbon atoms, an alkoxy group having 1 to 5 carbon atoms, a thioalkoxy group having 1 to 5 carbon atoms, a thioaryloxy group having 6 to 14 carbon atoms, and an aryl group having 6 to 14 carbon atoms, and combinations thereof, and
each F2 is independently selected from a hydrogen atom, a vinylbenzyl group

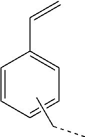

or a structure of the Formula F3, provided that at least one F2 is a structure of the formula F3:

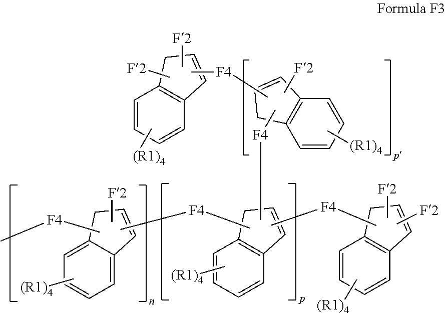

Wherein:
   n, p and p′, independently, can range from 0 to 50, preferably from 0 to 10,
   each R1 is independently selected from a hydrogen atom, a halogen atom, an alkyl group having 1 to 5 carbon atoms, an alkoxy group having 1 to 5 carbon atoms, a thioalkoxy group having 1 to 5 carbon atoms, a thioaryloxy group having 6 to 14 carbon atoms, and an aryl group having 6 to 14 carbon atoms, and combinations thereof,
   each F′2 is independently selected from a hydrogen atom, a vinylbenzyl group, provided that at least one F2 or one F′2 is a vinylbenzyl group,

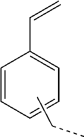

F4 is selected from divalent groups of the Formula F4 or combinations thereof:

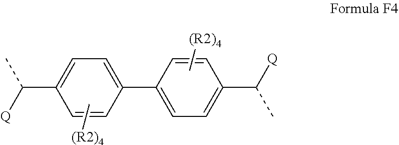

Wherein:
Each Q is independently selected from a hydrogen atom and a linear or branched C1-C6 alkyl group, or combinations thereof;
and
each R2 is independently selected from a hydrogen atom, a linear or branched C1-C6 alkyl group, a halogen atom, or combinations thereof.

The above disclosed curable resin composition comprising at least:
(1) A compound having the formula C1, and
(2) A compound having the formula C2,
is advantageously obtained by the above disclosed method comprising at least the steps of:
(i) mixing at least the compounds (a), (b), and (c), and
(ii) reacting said compounds in the presence of an alkali.

However, the curable resin composition comprising at least one compound C1, and at least one compound C2 can be obtained by other methods well known to the skilled professional and is not limited to those obtained by the above disclosed method. One of those methods is mixing a compound C1 with a compound C2.

The method comprising at least the steps of:
(i) mixing at least the compounds (a), (b), and (c), and
(ii) reacting said compounds in the presence of an alkali,
gives access to compositions comprising other compounds, well known to the skilled professional, in addition to compounds of formula C1 and compounds of formula C2.

The present invention further concerns a process for manufacturing an article, comprising at least the following steps:

### Step 1:

Preparing a curable resin composition according to the method disclosed above, or Preparing a curable resin composition comprising at least a compound having the formula C1 and at least a compound having the formula C2 as above disclosed, Said composition optionally comprising one or more additive, including for example, curing agents, curing accelerators, radical inhibitors, fillers;

### Step 2:

Shaping the composition,

### Step 3:

Curing the composition.

The invention also relates to articles obtained by said method.

### BRIEF DESCRIPTION OF THE DRAWINGS

FIG. 1 shows an 1H-NMR spectrum of Compound 1 of Example 1;

FIG. 2 shows an 1H-NMR spectrum of Compound 2 of Example 2;

FIG. 3 shows an 1H-NMR spectrum of Compound 3 of Example 3;

FIG. 4 shows an 1H-NMR spectrum of Compound 4 of Example 4;

FIG. 5 shows an 1H-NMR spectrum of Compound 5 of Example 5; and

FIG. 6 shows an 1H-NMR spectrum of Compound 6 of Comparative Example 6.

### GENERAL DESCRIPTION

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

As used herein, the singular forms “a”, “an”, and “the” include both singular and plural referents unless the context clearly dictates otherwise. By way of example, “a halogen” means one halogen atom or more than halogen atom.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”. This means that, preferably, the aforementioned terms, such as “comprising”, “comprises”, “comprised of”, “containing”, “contains”, “contained of”, can be replaced by “consisting”, “consisting of”, “consists”.

Throughout this application, the term “about” is used to indicate that a value includes the standard deviation of error for the device or method being employed to determine the value.

As used herein, the terms “% by weight”, “wt %”, “weight percentage”, or “percentage by weight” are used interchangeably.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

The term “CX-CY alkyl” refers to a linear or branched hydrocarbyl radical having X to Y carbon atoms, and “substituted alkyl” refers to an alkyl further bearing one or more substituents selected from hydroxy, alkoxy, mercapto, cycloalkyl, heterocyclic, aryl, heteroaryl, aryloxy, halogen, trifluoromethyl, cyano, nitro, nitrone, amino, amido, C(O)H, acyl, oxyacyl, carboxyl, carbamate, sulfonyl, sulfonamide, and sulfuryl.

The term “cycloalkyl” refers to a divalent cyclic ring-containing group containing in the range of 3 to 8 carbon atoms, and “substituted cycloalkyl” refers to a cycloalkyl further bearing one or more substituents selected from hydroxy, alkoxy, mercapto, cycloalkyl, heterocyclic, aryl, heteroaryl, aryloxy, halogen, trifluoromethyl, cyano, nitro, nitrone, amino, amido, C(O)H, acyl, oxyacyl, carboxyl, carbamate, sulfonyl, sulfonamide, and sulfuryl.

The term “aryl” refers to a divalent aromatic group having 6 to 14 carbon atoms and “substituted aryl” refers to an aryl further bearing one or more substituents selected from hydroxy, alkoxy, mercapto, cycloalkyl, heterocyclic, aryl, heteroaryl, aryloxy, halogen, trifluoromethyl, cyano, nitro, nitrone, amino, amido, C(O)H, acyl, oxyacyl, carboxyl, carbamate, sulfonyl, sulfonamide, and sulfuryl.

The term “heteroaryl” refers to a divalent aromatic group containing one or more heteroatoms (e.g., N, O, S, or the like) as part of the ring structure, and having in the range of 3 to 14 carbon atoms; and “substituted aryl” refers to arylene groups further bearing one or more substituents selected from hydroxy, alkoxy, mercapto, cycloalkyl, heterocyclic, aryl, heteroaryl, aryloxy, halogen, trifluoromethyl, cyano, nitro, nitrone, amino, amido, C(O)H, acyl, oxyacyl, carboxyl, carbamate, sulfonyl, sulfonamide, and sulfuryl.

The term “halogen” refers to an atom selected from Cl, Br, I.

The terms “dielectric dissipation factor (Df)” and “loss tangent,” as used herein, are synonymous and refer to the amount of energy dissipated (i.e., electrical loss) into an insulating material when a voltage is applied to the circuit. Df represents the loss of the signal in the circuit.

The terms “dielectric constant (Dk)” and “permittivity,” as used herein, are synonymous and refer to a measurement of the relative capacitance of an insulating material to that of air or vacuum. The dielectric constant determines the speed of the electronic signal.

All references cited in the present specification are hereby incorporated by reference in their entirety. In particular, the teachings of all references herein specifically referred to are incorporated by reference.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

Throughout this application, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous. Although the preferred embodiments of the invention have been disclosed for illustrative purpose, those skilled in the art will appreciate that various modifications, additions or substitutions are possible, without departing from the scope and spirit of the invention as disclosed in the accompanying claims.

### The Compounds

According to a favorite embodiment of the invention, the curable composition comprising at least a compound C1 and at least a compound C2 is obtained by reacting one or more indene compound represented by the above general Formula 1 with one or more dimethylbiphenyl compound of the Formula 2 and one or more vinylbenzyl compound of the Formula 3 in the presence of an alkali. Optionally a fluorene compound can be part of the reaction mixture. The reaction can be carried out in accordance with conditions known for a vinylbenzylation reaction. The vinylbenzylation reaction is described, for example, by US2005/0176909.

According to the invention, in the formula 1 representing the indene compound and/or in compounds C1 and/or compounds C2, the R1 groups are located on the phenyl part of the indene bicycle.

According to a favorite embodiment, in the general Formula 1 representing the indene compound and/or in compounds C1 and/or compounds C2:
all R1 groups represent H, or
one R1 group is a halogen atom, or an alkyl group having 1 to 5 carbon atoms, or an alkoxy group having 1 to 5 carbon atoms, and the other R1 groups represent H.

According to a most favorite embodiment, all R1 groups represent H and the compound of general Formula 1 is indene.

According to a favorite embodiment, in the general Formula 2 representing the biphenyl compound, X is selected from a halogen atom, a tosylate, a mesylate, a triflate, and combinations thereof, more preferably a halogen atom, advantageously Cl or Br.

Preferably, all X are identical. Even more preferably, all X are Cl.

According to a favorite embodiment, in the general Formula 2 representing the biphenyl compound, in Formula F4, each Q is independently selected from H, CH3, C2H4, and combinations thereof, more preferably each Q is independently selected from H, CH3, and combinations thereof. Preferably all Q are identical. According to a most preferred embodiment, all Q are H.

According to a favorite embodiment, in the general Formula 2 representing the biphenyl compound, R2 is independently selected from H, CH3 and combinations thereof. Preferably, all R2 are identical. Preferably, all R2 are H.

According to a favorite embodiment, the compound (b) of general Formula 2 is 4,4′-bis(chloromethyl)biphenyl.

According to a most favorite embodiment, the compound (b) of general Formula 1 is indene and the compound (b) of general Formula 2 is 4,4′-bis(chloromethyl)-biphenyl.

According to a favorite embodiment, in the general Formula 3 representing the vinylbenzyl compound, X′ is selected from Cl, Br, I, a tosylate, a mesylate, a triflate, and combinations thereof, more preferably from Br, Cl and combinations thereof. The —CH2—X′ group can be positioned on the ortho, meta or para position of the aromatic cycle or can be a mixture of isomers of position.

According to a most favorite embodiment, the vinylbenzyl compound represented by the general Formula 3 is selected from the group comprising 2-vinylbenzyl chloride, 3-vinylbenzyl chloride, 4-vinylbenzyl chloride, 2-vinylbenzyl bromide, 3-vinylbenzyl bromide, 4-vinylbenzyl bromide and mixtures thereof.

More preferably, the vinylbenzyl compound represented by the general Formula 3 is a mixture of 10-50% by weight of 2-vinylbenzyl chloride, 0-10% by weight of 3-vinylbenzyl chloride and 50-80% by weight of 4-vinylbenzyl chloride.

More preferably, in compound C2, F′2 is a vinylbenzyl compound corresponding to a mixture of 10-50% by weight of 2-vinylbenzyl substituent, 0-10% by weight of 3-vinylbenzyl substituent and 50-80% by weight of 4-vinylbenzyl substituent.

Preferably, in compound C2, each F3 independently verifies n+p ranges from 0 to 50, preferably from 0 to 10.

Preferably, in compound C2, each F2 is independently selected from a hydrogen atom, a vinylbenzyl group or a structure of the Formula F3 with p=0.

In the method according to the invention, the molar ratio of the indene compound of Formula 1 to the dimethylbiphenyl compound of Formula 2 is selected so that gelation, or precipitation, is not caused by the dimethylbiphenyl compound of Formula 2. When the amount of the vinylbenzyl compound of Formula 3 is too low, curability deteriorates and the physical properties such as heat resistance of the cured product deteriorate.

The preferred molar ratio of all halomethyl, preferably chloromethyl, groups, if present, in compounds (b) and (c) to the reactive sites in compound (a) is 0.95 or lower. “Halomethyl group” (also known as “methylhalide radical”) in this context means a methyl group substituted with one halogen atom, which results if, in Formula 2, Q=H and X=halogen and, in Formula 3, X′=halogen. “Reactive site” in this context designates a carbon atom in the 5-membered indene ring with an acidic hydrogen which can be deprotonated by the alkali used in step (ii).

The molar ratio of the indene compound of Formula 1 to the dimethylbiphenyl compound of Formula 2 is preferably in the range of 1.8/1 to 3/1.

The molar ratio of the indene compound of Formula 1 to the vinylbenzyl compound of Formula 3 is preferably in the range of 1/1 to 1/2, preferably 1/1.75, most preferably 1/1.5.

Preferably, at least two, most preferably all three of the above conditions for the ratios of the compounds should be met to achieve optimum results.

### The Reaction

The reaction (ii) of compounds (a), (b), and (c), in the presence of an alkali is advantageously implemented in the following conditions:

Advantageously, the reaction is implemented in a solvent. Suitable reaction solvents include non-polar solvents such as toluene, xylene, or aprotic polar solvents such as dimethylformamide, dimethyl sulfoxide, dimethyl acetamide, N-methylpyrrolidone, dioxane, acetonitrile, tetrahydrofuran, ethylene glycol dimethyl ether, 1,3-dimethoxypropane, 1,2-dimethoxypropane, tetramethylene sulfone, hexamethyl phosphamide, methyl ethyl ketone, methyl isobutyl ketone, acetone, cyclohexanone, and mixtures thereof, preferably, from toluene, xylene, methylethylketone and mixtures thereof. A solvent may be selected from this list according to the types of raw materials and reaction conditions so that the reaction mixture is entirely solubilized in the solvent.

Examples of the alkali that can be used in the present invention include alkoxides, hydrides, hydroxides of an alkali metal or alkali earth metal and combinations thereof, such as sodium hydroxide, sodium methoxide, sodium ethoxide, sodium hydride, sodium borohydride, potassium hydride and potassium hydroxide. The alkali is introduced into the reaction mixture as a solution in water.

The amount of the alkali is preferably from 1 to 3 equivalents based on the sum of X groups and X′ groups in the compounds of formula 2 and compounds of formula 3 which are introduced in the reaction mixture. When the amount is less than 1 equivalents, the reaction rate becomes very low and the reaction does not proceed completely, which is detrimental to the physical properties of the cured product. When the amount of the alkali is beyond 3 equivalents, conditions for removing the residual alkali, such as washing, are more tedious and more costly.

Preferably, an onium-salts based catalyst is introduced in the mixture of reactants of step (i). Advantageously, the onium-salt based catalyst is selected from the list comprising tetra-n-butylammonium bromide, tetra-n-butylammonium chloride, tetra-n-butylammonium hydrogen sulfate, benzyltrimethylammonium chloride, and tricaprylmethylammonium chloride, tetra-n-butylphosphonium bromide, benzyltriphenylphosphonium chloride, tetraphenylphosphonium chloride, tetraphenylphosphonium bromide, benzyltetramethylene sulfonium bromide, and mixtures thereof.

The reaction temperature and reaction time can vary according to the types of raw material compound and the expected physical characteristics of the curable composition. As a general indication, the temperature of the reaction mixture can be from 30° C. to 100° C. When the reaction temperature is too high, other, not preferred, reactions can occur, such as thermal polymerization. When the reaction temperature is too low, the reaction proceeds at a slow rate, which is not advantageous from an industrial and economical perspective. As a general indication, the duration of the reaction can be from 0.5 hours to 20 hours.

### The Curable Resin Composition

In this chapter, the percentages are expressed by weight of compounds C1 and compounds C2 with regards to the total weight of the resin, possibly including other products resulting from the reaction of the compounds (a), (b), and (c), but excluding the optional additives which are detailed here-under.

Advantageously, in the resin composition, the amount of the one or more compound C1 ranges from 1 to 50 wt. %, based on the total weight of the total weight of the resin composition.

Advantageously, in the resin composition, the amount of the one or more compound C2 ranges from 50 to 99 wt. %, based on the total weight of the total weight of the resin composition.

The following characteristics of the resin composition according to the invention relate to the mixture of C1 and C2 or to the product resulting from the above disclosed method.

Advantageously, the resin composition according to the invention has a weight average molecular weight, measured by GPC, by the method ISO 13885-1:2020, ranging from Mw=500 g/mol to 10000 g/mol, more preferably, from 500 to 5000 g/mol.

Advantageously, the resin composition according to the invention has a polydispersity, measured by GPC, by the method ISO 13885-1:2020 ranging from 2.01 to 5, more preferably, from 2.01 to 3.

### Additional Components

Before curing, the curable resin composition can be mixed with varied additives selected according to the intended application and expected properties. Such additives are detailed here-under in a non-limiting manner. In this chapter, the percentages are expressed by weight of additional compounds with regards to the total weight of the additivated resin composition. The amounts recited are in addition to the mixture of compounds C1 and C2, and/or in addition to the compounds resulting from the reaction of the compounds (a), (b), and (c.

Using a co-curing agent in the resin composition permits to reduce the curing temperature or promote the curing reaction. According to a favorite embodiment, the composition of the invention includes at least a co-curing agent, which can be selected from, for example, polyphenylene ether derivatives, maleimides, bismaleimides, styrenes, divinylbenzenes, trivinylcyclohexanes, trialkenyl isocyanurate compounds such as triallyl isocyanurate (TAIC) and mixtures thereof.

Polyphenylene ether derivatives are commercially available. Examples are Noryl™ SA9000 Resin, manufactured by Sabic, and OPE-2St 1200 and OPE-2St 2200, manufactured by Mitsubishi Gas Chemical Company, Inc.

The amount of co-curing agent used is adapted according to the type and content of unsaturated groups contained in the curable resin composition, the choice of a particular co-curing agent, its half-life temperature and required stability. In one embodiment, the composition of the present invention may include the co-curing agent and mixtures thereof in an amount within a range of about 1% to about 90% by weight or within a range of about 5% to about 50% by weight based on the total weight of the additivated composition.

Although the resin composition of the present disclosure may be cured by mere heating, a curing catalyst that generates a cation or free radical species may be added in order to improve the curing efficiency. Examples of such curing catalysts include, but are not limited to, diaryliodonium salts, triarylsulfonium salts and aliphatic sulfonium salts, which contain BF4, PF6, AsF6 or SbF6 as a counter anion, benzoin type compounds such as benzoin and benzoin methyl, acetophenone type compounds such as acetophenone and 2,2-dimethoxy-2-phenylacetophenone and the like; thioxanthone type compounds such as thioxanthone and 2,4-diethylthioxanthone, bisazide compounds such as 4,4′-diazidochalcone, 2,6-bis(4-azidobenzal)cyclohexanone and 4,4′-diazidobenzophenone, azo compounds such as azobisisobutyronitrile, 2,2-azobispropane, and 2,2′-azobis(2,4,4-trimethylpentane), organic peroxides such as 2,5-dimethyl-2,5-di(t-butylperoxy)hexane, 2,5-dimethyl-2,5-di(t-butylperoxy)hexyne-3 and dicumyl peroxide.

The composition of the invention may contain the curing catalyst in an amount of about 0.1%-10% by weight or about 0.3%-7% by weight or about 0.5%-5% by weight or about 1%-3% by weight, where the % by weight is based on the total weight of the additivated composition.

In another embodiment, a polymerization inhibitor may optionally be added to the composition in order to enhance the storage stability. Examples include quinones, phenols, catechols, phenothiazines, (2,2,6,6-tetramethylpiperidin-1-yl)oxyls and hydroxylamines and their corresponding salts, such as hydroquinone, p-benzoquinone, 2,6-di-tert-butyl-4-methylphenol, phenothiazine, (2,2,6,6-tetramethylpiperidin-1-yl)oxyl and 4-t-butylpyrocatechol. The composition may include from about 0.0005%-5% by weight of the polymerization inhibitor when present, where the % by weight is based on the total weight of the additivated composition.

In a particularly preferred embodiment, the resin composition may optionally include an inorganic filler, organic filler or mixture thereof. Fillers contemplated for use in the practice of the present disclosure may be any of a variety of morphologies, e.g., angular, platelet, spherical, amorphous, sintered, fired, powder, flake, crystalline, ground, crushed, milled, and the like, or mixtures of any two or more thereof. Presently preferred particulate fillers contemplated for use herein are substantially spherical.

Such fillers may optionally be thermally conductive. Both powder and flake forms of filler may be used in the resin compositions of the present disclosure. Fillers having a wide range of particle sizes can also be employed in the practice of the present disclosure.

Particle sizes ranging from about 500 nm up to about 300 microns may be employed, with particle sizes of less than about 100 microns being preferred, and particle sizes in the range of about 5 up to about 75 microns being particularly preferred.

A wide variety of fillers can be employed in the practice of the present disclosure, e.g., soft fillers (e.g., uncalcined talc), naturally occurring minerals (e.g., aluminum nitride, boron nitride, silicon carbide, diamond, graphite, beryllium oxide, magnesia, silica, alumina, aluminum silicates, and the like), calcined naturally occurring minerals (e.g., enstatite), synthetic fused minerals (e.g., cordierite), treated fillers (e.g. silane-treated minerals), organic polymers (e.g., polytetrafluoroethylene), hollow spheres, microspheres, powdered polymeric materials, and the like.

Exemplary fillers include talc, mica, calcium carbonate, calcium sulfate, aluminum nitride, boron nitride, silicon carbide, diamond, graphite, beryllium oxide, magnesia, silica, alumina, TiO2, aluminum silicate, aluminum-zirconium-silicate, cordierite, silane-treated mineral, polytetrafluoroethylene, polyphenylene sulfide, and the like.

Thermally conductive fillers contemplated for optional use in the practice of the present disclosure include, for example, aluminum nitride, boron nitride, silicon carbide, diamond, graphite, beryllium oxide, magnesia, silica, alumina, zirconium silicate, and the like. Preferably, the particle size of these fillers will be about 20 microns. If aluminum nitride is used as a filler, it is preferred that it is passivated via an adherent, conformal coating (e.g., silica, or the like).

Preferably said filler is a silane treated filler, more preferably a silane treated amorphous silica. When fillers are present, the additivated resin composition may contain up to about 75% by weight, or up to about 50% by weight, or up to about 25% by weight, or up to about 10% by weight of the filler, where the % by weight is based on the total weight of the additivated composition.

The resin composition of the present disclosure may optionally include one or more additives such as flexibilizers, anti-oxidants, dyes, pigments, surfactants, defoamers, silane coupling agents, dispersing agents, thixotropic agents, processing aids, flow modifiers, cure accelerators, strength enhancers, toughening agents, UV protectors (especially UV blocking dyes appropriate to enable Automatic-Optical Inspection (AOI) of Circuitry), flame retardants and the like, as well as mixtures of any two or more thereof.

Flexibilizers (also called plasticizers) contemplated for use in certain embodiments of the present invention include compounds that reduce the brittleness of the formulation, such as, for example, branched polyalkanes or polysiloxanes that lower the glass transition temperature of the compositions. Such plasticizers include, for example, polyethers, polyesters, polythiols, polysulfides, polybutadienes, styrene-based block copolymers, polybutadiene-polystyrene copolymers such as those sold under the Poly BD® and RICON® brand names. Plasticizers, when employed, are typically present in the range of about 0.5% by weight up to about 30% by weight of the additivated composition.

Antioxidants contemplated for use in the practice of the present invention include hindered phenols (e.g., BHT (butylated hydroxytoluene), BHA (butylated hydroxyanisole), TBHQ (tertiary-butyl hydroquinone), 2,2′-methylenebis(6-tertiarybutyl-p-cresol), and the like), hindered amines (e.g., diphenylamine, N,N′-bis(1,4-dimethylpentyl-p-phenylene diamine, N-(4-anilinophenyl)methacrylamide, 4,4′-bis(α,α-dimethylbenzyl)diphenylamine, and the like), phosphites, and the like. When used, the quantity of antioxidant typically falls in the range of about 100 up to 2000 ppm, relative to the weight of the additivated composition.

Dyes contemplated for use in certain embodiments of the present disclosure include nigrosine, Orasol blue GN, phthalocyanines, fluorescent dyes (e.g., Fluoral green gold dye, and the like), and the like. When used, organic dyes in relatively low amounts (i.e., amounts less than about 0.2% by weight relative to the weight of the additivated composition) provide contrast.

Pigments contemplated for use in certain embodiments of the present disclosure include any particulate material added solely for the purpose of imparting color to the formulation, e.g., carbon black, metal oxides (e.g., Fe2O3, titanium oxide), and the like.

When present, pigments are typically present in the range of about 0.5% by weight up to about 5% by weight, relative to the weight of the additivated resin composition.

Toughening agents contemplated for use in the practice of the disclosure are materials which impart enhanced impact resistance to various articles. Exemplary toughening agents include synthetic rubber containing compounds such as Hypro, Hypox, and the like.

UV protectors contemplated for use in certain embodiments of the present invention include compounds which absorb incident ultraviolet (UV) radiation, thereby reducing the negative effects of such exposure on the resin or polymer system to which the protector has been added. Exemplary UV protectors include bis(1,2,2,6,6-pentamethyl-4-piperidinyl) sebacate, silicon, powdered metallic compounds, hindered amines (known in the art as “HALS”), and the like.

Defoamers contemplated for use in certain embodiments of the present invention include materials which inhibit formation of foam or bubbles when a liquid solution is agitated or sheared during processing. Exemplary defoamers contemplated for use herein include n-butyl alcohol, silicon-containing anti-foam agents, and the like.

Exemplary silane coupling agents contemplated for use in the practice of the present invention include materials which form a bridge between inorganic surfaces and reactive polymeric components, including materials such as epoxy silanes, amino silanes, and the like.

Exemplary thixotropic agents contemplated for use in the practice of the present invention include materials which cause liquids to have the property of enhanced flow when shear is applied, including materials such as high surface area fillers (e.g., fumed silica) having particle sizes in the range about 2-3 microns, or even submicron size.

### Curinq

After preparing the curable resin composition, for example by implementing the method comprising mixing compounds (a), (b) and (c), and reacting them in the presence of an alkali, or alternately by mixing one or more compounds C1 and one or more compounds C2, or by any other method, the resin is separated from the reaction medium. The resin which is obtained can be used for varied applications. Especially, the resin is used as such or mixed with one or more additives, such as the additives cited above as examples, before curing to give a cured article.

The resin composition of the present disclosure may be prepared by appropriately mixing the above recited components, i.e. mixing the mixture of C1/C2, or the product resulting from the reaction of compounds (a), (b), and (c), with the additives which have been disclosed above (co-curative, fillers, antioxidant, catalyst, etc.), and also kneading or mixing, as needed, by a kneading means such as a three roll mill, a ball mill, a bead mill or a sand mill, or a stirring means such as a high-speed rotary mixer, a super mixer or a planetary mixer.

In another embodiment, the composition may be dissolved or dispersed in an organic solvent to form a resin composition varnish, before curing. The amount of solvent is not limited, but typically is used in an amount sufficient to provide a concentration of solids in the solvent of at least 30% by weight to no more than 90% by weight solids, or between about 50%-85% by weight solids, or between about 55%-75% weight solids.

The organic solvent is not specifically limited and may be a ketone, an aromatic hydrocarbon, an ester, an amide or an alcohol. More specifically, examples of organic solvents which may be used include, acetone, methyl ethyl ketone, methyl isobutyl ketone, cyclohexanone, toluene, xylene, methoxyethyl acetate, ethoxyethyl acetate, butoxyethyl acetate, ethyl acetate, N-methylpyrrolidone formamide, N-methylformamide, N,N-dimethylacetamide, methanol, ethanol, ethylene glycol, ethylene glycol monomethyl ether, ethylene glycol monoethyl ether, diethylene glycol, triethylene glycol monomethyl ether, triethylene glycol monoethylether, triethylene glycol, propylene glycol monomethyl ether, dipropylene glycol monoethyl ether, propylene glycol monopropyl ether, dipropylene glycol monopropyl ether, and mixtures thereof.

The curable resin composition of the present invention can be cured by a known method such as heat, light or an electron beam.

When the resin is cured by heat, the curing temperature differs according to the type of the polymerizable unsaturated group and the type and amount of the curing agent used. Generally, the curing temperature ranges from 20° C. to 250° C., preferably from 50° C. to 250° C.

### Applications

In accordance with yet another embodiment of the present disclosure, there are provided articles comprising a partially or fully cured layer of the above-described composition, preferably in association with a substrate.

The cured article can be suitably used in organic insulating materials, etc. for use in electronic equipment such as communications equipment, especially for manufacturing a high-frequency laminate.

It has been discovered that using the present composition of the invention enables to reach ultra-low loss factor Df in the gigahertz range (e.g., 1-10 GHz, well below 0.00179 at 10 GHz), which is unexpected in view of the prior art.

Specifically, the curable resin compositions according to the invention give access, after curing, to articles having a dielectric dissipation factor (Df) measured on a Split Post Dielectric Resonator (SPDR) at a frequency of 10 GHz below 0.00100. It is important to note that the characterization of the dielectric dissipation factor of organic films by SPDR is associated with max 10% uncertainty with errors typically on the 4^{th} decimal place. Moreover, it is known in the field that reducing the dissipation factor of hydrocarbon materials below 0.00100 can be challenging due to defects typically introduced in the polymer structures.

According to a favorite embodiment, the articles resulting from curing compositions of the present disclosure have a dielectric constant (Dk) at 10 GHz of less than about 3 or less than about 2.9 or less than about 2.8.

The selection of the biphenyl compound of Formula 2 and/or the biphenyl radical of Formula F4 provides particular effects to the composition. This ultra-low loss resin can be used for manufacturing copper clad laminates (CCL), which are also used to manufacture printed circuit boards (PCBs). PCBs obtained from the resin composition according to the invention demonstrate improvements to existing material solutions, in particular in terms of processing, dielectric properties, thermomechanical properties, and reduced water sensitivity. The composition of the present invention confers the main final properties to PCBs. The composition of the present invention enables to provide a resin, which shows higher thermomechanical properties, as well as higher humidity resistance. The effects stemming from the composition of the present invention are also related to higher thermal decomposition temperature (Td2/Td5), higher thermal properties (G′ onset) and a lower loss (dissipation) factor (Df).

The invention relates to a method for manufacturing an article, said method comprising at least the steps of preparing a curable resin composition, shaping the composition and curing the composition.

In the context of the invention, preparing a curable resin composition means:
Preparing a curable resin composition according to the method disclosed above, or
Preparing a curable resin composition comprising at least a compound having the formula C1 and a compound having the formula C2 as above disclosed,
said composition optionally comprising one or more additive like for example catalyst curing agents, crosslinking curing agents, curing accelerators, radical inhibitors, fillers.

Shaping includes structuring the composition by giving it the expected shape, and/or associating the composition with another material, for example a support material, also designated as substrate or supporting article. Shaping may include a step of dissolving the resin composition in a solvent.

Here-under are detailed several variants of the method according to the invention for manufacturing an article:

The present invention further concerns a process for manufacturing an article, for example a high-frequency laminate, comprising at least the following steps:
Step 1: Preparing a curable resin composition,
Step 2: Dissolving the curable resin composition of step 1 in a solvent to form a varnish and applying the varnish to a supporting article,
Step 3: Curing the composition.

Applying the varnish to a supporting article can be implemented by any method known to the skilled professional, like for example, brush-painting the curable resin composition on the supporting article, spraying the curable resin composition on the supporting article, or spin-coating the curable resin composition on the supporting article.

The present invention further concerns a process for manufacturing an article, especially a high-frequency laminate, comprising at least the following steps:
Step 1: Preparing a curable resin composition,
Step 2: Impregnating a support material, especially a fiber material with the composition of step 1,
Step 3: Curing the composition.

Impregnating a fiber material with the curable resin composition can be implemented by any method known to the skilled professional, like for example, dipping the fiber material in a solution of the curable resin composition, or spraying the curable resin composition on the fiber material, or spin-coating the curable resin composition on the fiber material. Such a method may require dissolving the curable resin composition in a solvent to form a varnish.

The present invention further concerns a process for manufacturing an article, comprising at least the following steps:
Step 1: Preparing a curable resin composition,
Step 2: Introducing the composition of step 1 into a mold,
Step 3: Curing the composition.

The present invention also relates to an article obtained by a method comprising at least a step of curing a composition according to the invention.

The compositions of the present invention enable to provide products which can be used in a variety of applications, such as prepregs, metal clad laminates (e.g. copper clad laminates), printed circuit boards, light emitting diodes and electronic coatings.

Especially, the present invention relates to a prepreg obtained by impregnating a fiber material with a curable resin composition according to the invention and curing said resin.

The present invention also provides a laminated sheet, which can be used as high-frequency laminate, wherein said laminated sheet comprises the prepreg as defined above and a layer of an electrically conductive material disposed on at least one surface of the prepreg.

The invention is also directed to a printed wiring board produced by forming a conductive pattern on the surface of the laminated sheet as defined hereinabove.

As readily recognized by those of skill in the art, a variety of fiber materials are suitable as substrates/supporting article for use in the practice of the present disclosure, for example, polyesters, liquid crystalline polymers, polyamides (e.g., Aramids), polyimides, polyamide-imides, polyolefins, polyphenylene oxides, polyphenylene sulfides, polybenzoxazines, conductive materials (e.g., conductive metals), and the like, as well as combinations of any two or more thereof.

When conductive metal substrates are employed as supporting articles, such materials as silver, nickel, gold, cobalt, copper, aluminum, alloys of such metals, and the like, are contemplated for use herein.

In accordance with still another embodiment of the present disclosure, there are provided methods of making the above-described articles (i.e., articles comprising the composition according to the present disclosure on a substrate/supporting article), said methods comprising applying the resin composition to a substrate and, if an organic solvent is optionally employed to facilitate such application, removing substantially all organic solvent therefrom. The resin composition may be applied to the substrate by dipping, impregnating, spraying and the like.

In accordance with yet another embodiment of the present disclosure, there are provided prepregs produced by impregnating a porous substrate with a composition according to the present disclosure, and, if an organic solvent is optionally employed to facilitate such impregnation, subjecting the resulting impregnated substrate to conditions suitable to remove substantially all of the organic solvent therefrom.

As readily recognized by those of skill in the art, a variety of porous substrates can be employed for the preparation of inventive prepregs. The porous substrate may be woven or non-woven. The thickness of such substrate is not particularly limited, and may range, for example, from about 0.01 mm to 0.3 mm.

Examples of porous substrates can include, but are not limited to, woven glass, nonwoven glass, woven aramid fibers, non-woven aramid fibers, woven liquid crystal polymer fibers, non-woven liquid crystal polymer fibers, woven synthetic polymer fibers, nonwoven synthetic polymer fibers, randomly dispersed fiber reinforcements, expanded polytetrafluoroethylene (PTFE) structures and combinations of any two or more thereof.

Specifically, materials contemplated for use as the porous substrate can include, but are not limited to, fiberglass, quartz, polyester fiber, polyamide fiber, polyphenylene sulfide fiber, polyetherimide fiber, cyclic olefin copolymer fiber, polyalkylene fiber, liquid crystalline polymer, poly(p-phenylene-2,6-benzobisoxazole), copolymers of polytetrafluoroethylene and perfluoromethylvinyl ether (MFA) and combinations of any two or more thereof.

In accordance with still another embodiment of the present disclosure, there are provided laminated sheets produced by layering and molding a prescribed number of sheets of the above-described prepreg.

Laminated sheets according to the present disclosure have many particularly beneficial properties, such as, for example, low dielectric constant, low dissipation factor, high thermal decomposition temperature, and the like. In a preferred embodiment, laminated sheets according to the present disclosure have a dielectric constant ≤3.0 nominal and a dissipation factor ≤0.002 at 10 GHz, and a glass transition temperature of at least 100° C. or at least 150° C.

In one aspect of the present disclosure, laminated sheets as described herein may optionally further comprise one or more conductive layers. Such optional conductive layers are selected from the group consisting of metal foils, metal plates, electrically conductive polymeric layers, and the like. In one embodiment, the metal may be copper, silver, nickel, gold, cobalt, aluminum and alloys of such metals.

In another embodiment, there is provided a method of forming a laminated sheet. The method includes contacting the porous substrate with a varnish bath comprising the resin composition of the present disclosure dissolved and intimately admixed in a solvent or a mixture of solvents. The contacting occurs under conditions such that the porous substrate is coated with the resin composition. Thereafter the coated porous substrate is passed through a heated zone at a temperature sufficient to cause the solvent to evaporate, but below the temperature at which the resin composition undergoes significant cure during the residence time in the heated zone to form a prepreg.

The porous substrate preferably has a residence time in the bath of from 1 second to 300 seconds, more preferably from 1 second to 120 seconds, and most preferably from 1 second to 30 seconds. The temperature of such bath is preferably from 0° C. to 100° C., more preferably from 10° C. to 40° C., and most preferably from 15° C. to 30° C. The residence time of the coated porous substrate in the heated zone is from 0.1 minute to 15 minutes, more preferably from 0.5 minute to 10 minutes, and most preferably from 1 minute to 5 minutes.

The temperature of such zone is sufficient to cause any solvents remaining to volatilize away yet not so high as to result in a complete curing of the components during the residence time. Preferable temperatures of such zone are from 80° C. to 250° C., more preferably from 100° C. to 225° C., and most preferably from 150° C. to 210° C. Preferably there is a means in the heated zone to remove the solvent, either by passing an inert gas through the oven, or drawing a slight vacuum on the oven. In many embodiments the coated substrate is exposed to zones of increasing temperature. The first zones are designed to cause the solvent to volatilize so it can be removed. The later zones are designed to result in partial cure of the resin composition (B-staging).

One or more sheets of prepreg are preferably processed into laminates optionally with one or more sheets of electrically-conductive material such as copper. In such further processing, one or more segments or parts of the coated porous substrate are brought in contact with one another and/or the conductive material. Thereafter, the contacted parts are exposed to elevated pressures and temperatures sufficient to cause the components to cure wherein the resin on adjacent parts react to form a continuous resin matrix between the porous substrates. Before being cured the parts may be cut and stacked or folded and stacked into a part of desired shape and thickness. The pressures used can be anywhere from 1 psi to 1000 psi with from 10 psi to 800 psi being preferred. The temperature used to cure the resin composition in the parts or laminates, depends upon the particular residence time, pressure used, and components used. Preferred temperatures which may be used are between 100° C. and 250° C., more preferably between 120° C. and 220° C., and most preferably between 170° C. and 200° C. The residence times are preferably from 10 minutes to 120 minutes and more preferably from 20 minutes to 90 minutes.

In one embodiment, the process is a continuous process where the porous substrate is taken from the oven and appropriately arranged into the desired shape and thickness and pressed at very high temperatures for short times. In particular such high temperatures are from 180° C. to 250° C., more preferably 190° C. to 210 C, at times of 1 minute to 10 minutes and from 2 minutes to 5 minutes. Such high-speed pressing allows for the more efficient utilization of processing equipment. In such embodiments the preferred reinforcing material is a glass web or woven cloth.

In some embodiments it is desirable to subject the laminate or final product to a post cure outside of the press. This step is designed to complete the curing reaction. The post cure is usually performed at from 130° C. to 220° C. for a time period of from 20 minutes to 200 minutes. This post cure step may be performed in a vacuum to remove any components which may volatilize.

Thus, in accordance with yet another embodiment of the present disclosure, there are provided methods of making a laminated sheet, said method comprising layering and molding a prescribed number of sheets of a prepreg according to the present disclosure.

In accordance with a further embodiment of the present disclosure, there are provided printed wiring boards produced by forming conductive patterns on the surface of the above-described laminated sheet(s). Forming the conductive patterns may can be carried out by, for example, forming a resist pattern on the surface of the laminated sheet(s), removing unnecessary portions of the sheet by etching, removing the resist pattern, forming the required through holes by drilling, again forming the resist pattern, plating to connect the through holes, and finally removing the resist pattern.

In accordance with a still further embodiment of the present disclosure, there are provided multilayer printed wiring boards produced by layering and molding a prescribed number of sheets of the above-described patterned laminate layers, bonded together with one or more layers of prepreg from which the printed wiring board layer was prepared.

In accordance with a still further embodiment of the present invention, there are provided methods of making printed wiring boards, said methods comprising forming conductive patterns on the surface of a laminated sheet according to the present disclosure.

In accordance with yet another embodiment of the present disclosure, there are provided multilayer printed wiring boards produced by layering and molding a prescribed number of sheets of the above-described prepreg, to obtain a printed wiring board for an inner layer, and layering the prepreg on the printed wiring board for an inner layer which forms conductive patterns on the surface.

Accordingly, the prepreg and the printed wiring boards of the present disclosure may be usefully used as a component of a printed circuit board for a network for use in various electrical and electronic devices such as mobile communication devices that handle a high frequency signal of GHz or more, or the base station device thereof, and network-related electronic devices such as servers and routers, and large computers.

The present disclosure will now be further described with reference to the following non-limiting examples.

### Examples Section

### Materials & Methods

Tetrabutylammonium bromide (99+%). Supplier: Thermo Fisher Scientific, Belgium.
Vinylbenzyl chloride (mixture of o/m/p-isomers). Supplier: AK Scientific, Inc., USA.
Indene (90%, technical, stabilized). Supplier: Thermo Fisher Scientific, Belgium.
4,4′-Bis(chloromethyl)biphenyl (>95%). Supplier: Tokio Chemical Industry Co., LTD., Belgium.
α,α′-Dichloro-p-xylene (98%). Supplier: Merck KGaA, Germany.
TGA stands for Thermogravimetric Analysis according to ISO 11358.
DMA represents Dynamic Mechanical Analysis—ISO 6721.
GPC stands for Gel Permeation Chromatography.
1H-NMR: 1H-Nuclear Magnetic Resonance Spectroscopy.

G′ onset: The storage modulus G′ is the measure of the samples' elastic behavior. G′ onset means the temperature at which cured resins undergo a change from a glassy state to a softer, more rubbery, state.

Td2/Td5: Td2 is the temperature when the weight loss of the sample reaches 2%. Td5 is the temperature when the weight loss of the sample reaches 5%.

### Examples 1-5—According to the Invention

### Example 1

32.8 g (0.131 mol) 4,4′-bis(chloromethyl)biphenyl, 25.0 g (0.209 mol) indene, 3.4 g (0.010 mol) tetrabutylammonium bromide and 41.1 g (0.269 mol) vinylbenzyl chloride were dissolved in 500 mL toluene at an internal temperature of 40° C. under continuous stirring in a 1.5 liters reaction flask equipped with a mechanical stirrer, cooling condenser and dropping funnel to prepare a homogenous solution. 140 mL (2.610 mol) of a 50% by weight solution of NaOH in water was added dropwise over 30 minutes. After the addition was complete the internal temperature was increased to 50° C. by external heating. After 9 hours reaction time the mixture was diluted with water and the two layers separated. Toluene was removed by distillation to obtain 69.7 g (88% yield) of example 1 as a yellow solid material.

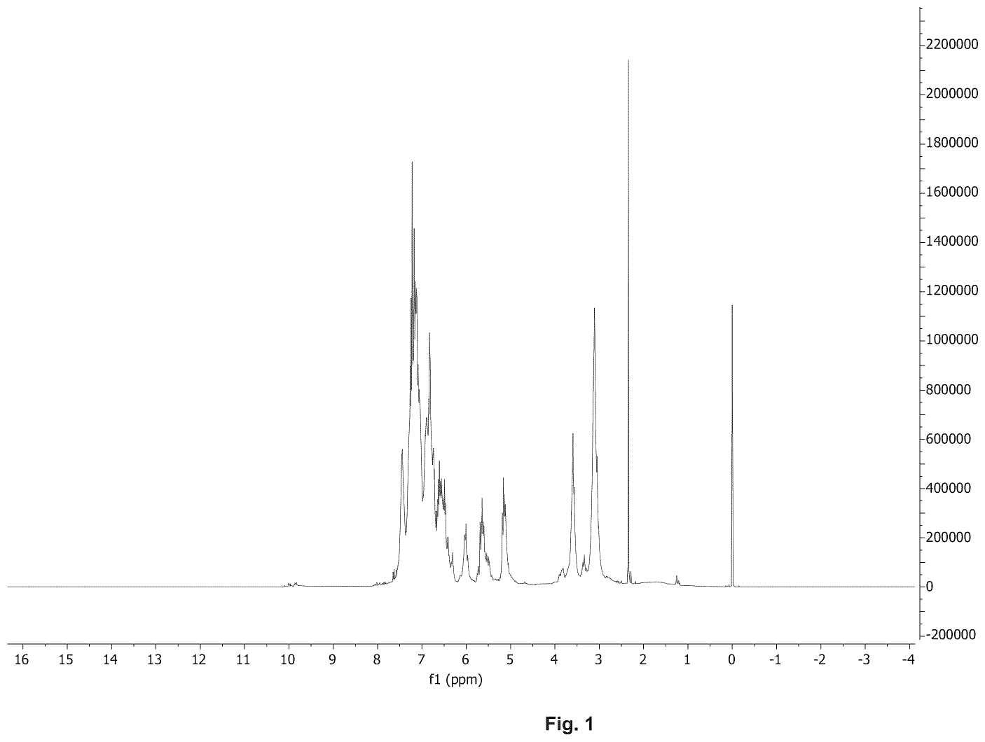

The obtained compound 1 of example 1 was identified from its 1H-NMR spectrum (FIG. 1) and GPC measurement. GPC indicated a weight average molecular weight Mw=2886 g/mol and a polydispersity of 2.8. The molar ratio of all chloromethyl groups to the reactive sites of the indene is 0.85.

### Example 2

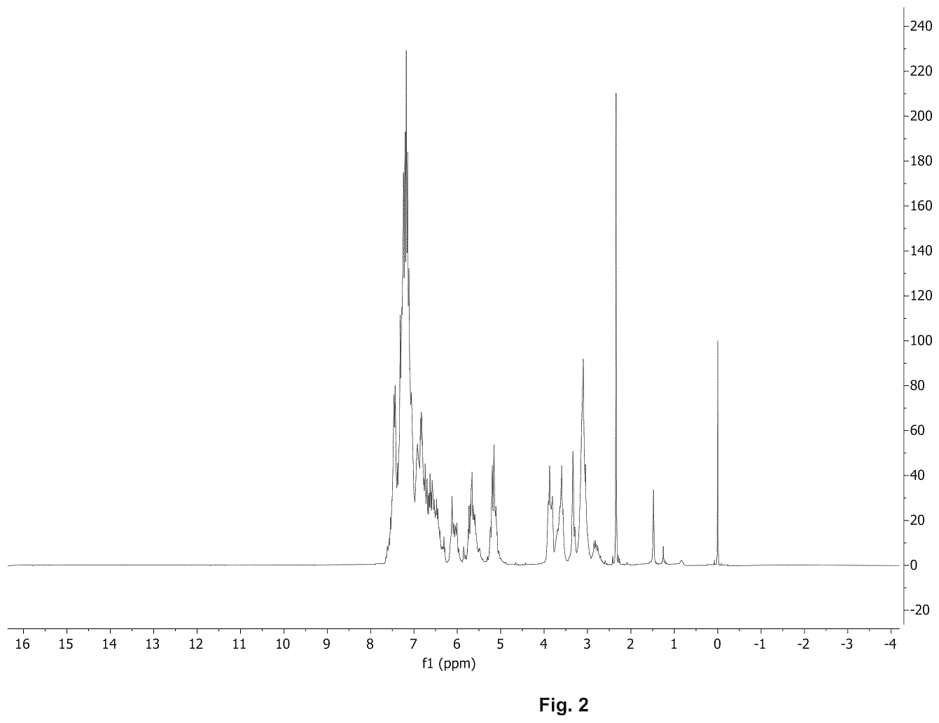

The same synthesis procedure as example 1 was used, except that another molar ratio was used between indene (1 molar equivalent), 4,4′-bis(chloromethyl)biphenyl (0.50 molar equivalent) and vinylbenzyl chloride (1.13 molar equivalent). Compound 2 was obtained as a yellow solid material in 86% yield and was identified from its 1H-NMR spectrum (FIG. 2) and GPC measurement. GPC indicated a weight average molecular weight Mw=1411 g/mol and a polydispersity of 2.6. The molar ratio of all chloromethyl groups to the reactive sites of the indene is 0.71.

### Example 3

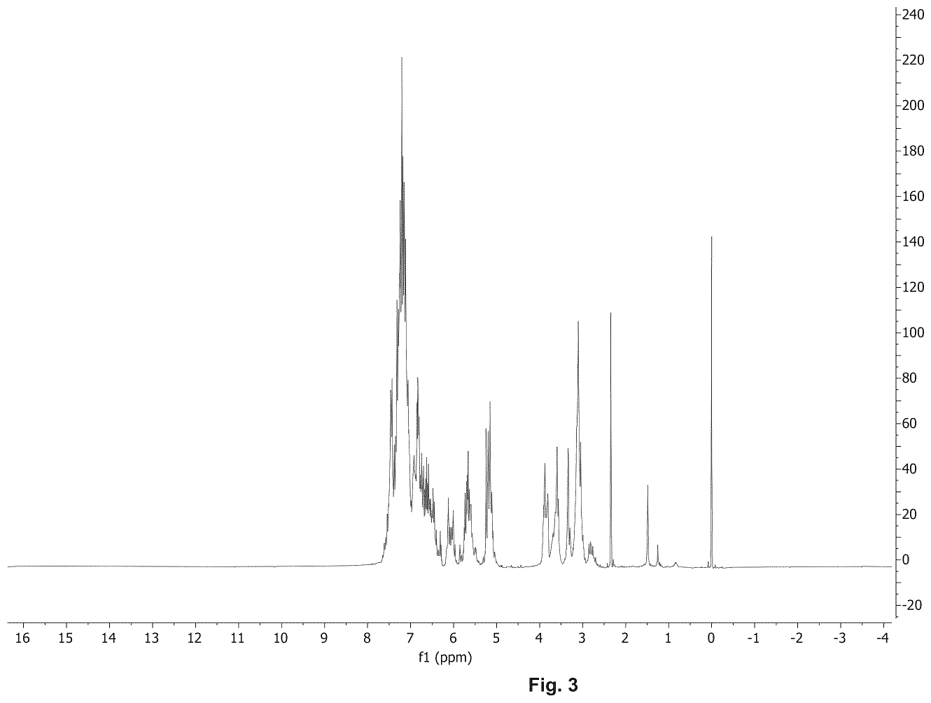

The same synthesis procedure as the one referred for example 1 above, except that a different molar ratio was used between indene (1 molar equivalent), 4,4′-bis(chloromethyl)biphenyl (0.40 molar equivalent) and vinylbenzyl chloride (1.34 molar equivalent). Compound 3 was obtained as a yellow solid material in 87% yield and was identified from its 1H-NMR spectrum (FIG. 3) and GPC measurement. GPC indicated a weight average molecular weight Mw=1091 g/mol and a polydispersity of 2.3. The molar ratio of chloromethyl groups to the reactive sites of the indene is 0.71.

### Example 4

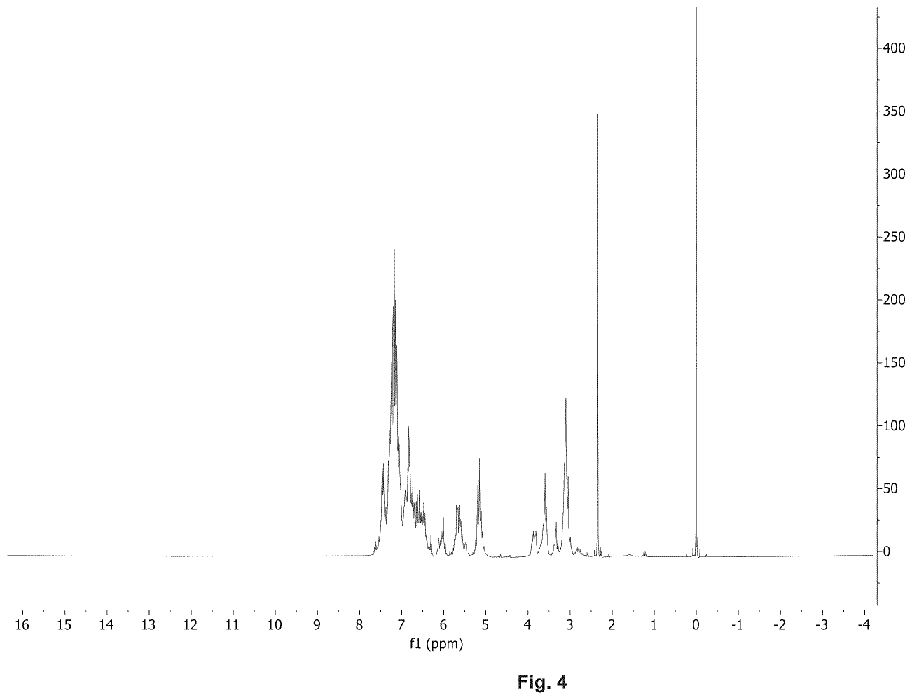

The same synthesis procedure as described for example 1 was used, except that a different molar ratio was used between indene (1 molar equivalent), 4,4′-bis(chloromethyl)biphenyl (0.44 molar equivalent) and vinylbenzyl chloride (1.47 molar equivalent). Compound 4 was obtained as a yellow solid material in 83% yield and was identified from its 1H-NMR spectrum (FIG. 4) and GPC measurement. GPC indicated a weight average molecular weight Mw=1216 g/mol and a polydispersity of 2.1. The molar ratio of all chloromethyl groups to the reactive sites of the indene is 0.78.

### Example 5

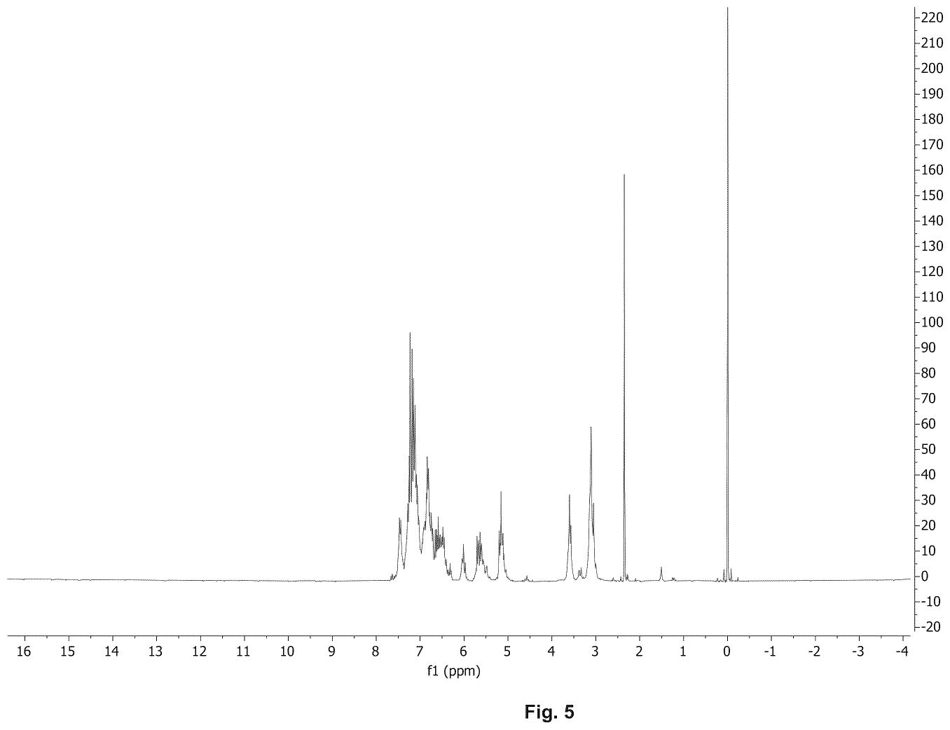

The same synthesis procedure as the one indicated for example 1 was used but with different molar ratio between indene (1 molar equivalent), 4,4′-bis(chloromethyl)biphenyl (0.51 molar equivalent) and vinylbenzyl chloride (1.73 molar equivalent). Compound 5 was obtained as a yellow solid material in 88% yield and example 5 was identified from its 1H-NMR spectrum (FIG. 5) and GPC measurement. GPC indicated a weight average molecular weight Mw=1726 g/mol and a polydispersity of 2.4. The molar ratio of all chloromethyl groups to the reactive sites of the indene is 0.92.

Table 1 below illustrates the composition disclosed above when mixed with a filler for examples 1 to 5.

TABLE 1

| | Ex. 1 | Ex. 2 | Ex. 3 | Ex. 4 | Ex. 5 |
|---|---|---|---|---|---|
| Component | (pbw) | (pbw) | (pbw) | (pbs) | (pbw) |
| Compound 1 | 100 | — | — | — | — |
| Compound 2 | — | 100 | — | — | — |
| Compound 3 | — | — | 100 | — | — |
| Compound 4 | — | — | — | 100 | — |
| Compound 5 | — | — | — | — | 100 |
| Fused silica^{a)} | 25 | 25 | 25 | 25 | 25 |

^{a)}SC2300-SVJ (Admatechs)

### Application Examples

### Application on a Metal Film

The compounds referred in table 1 were dissolved at room temperature in toluene at a concentration of 40% by weight after which the silica filler was added to produce a homogenous resin composition varnish. The homogenous resin compositions were casted on a metal plate and toluene was evaporated over night at ambient conditions. The pre-dried resin film was placed in an oven and cured stepwise under nitrogen using following cure cycle: 1 hour at 70° C., 1 hour at 90° C., 1 hour at 140° C., 2 hours at 200° C. The resulting plates with an approximate thickness of 0.5 mm were evaluated for the dielectric constant (Dk) and the dissipation factor (Df) on a Split Post Dielectric Resonator (SPDR) at a frequency of 10 Ghz and results are shown in Table 2 below.

TABLE 2

| Property | Ex. 1 | Ex. 2 | Ex. 3 | Ex. 4 | Ex. 5 |
|---|---|---|---|---|---|
| Dk/Df ^{a)} | 2.79/ | 2.86/ | 2.79/ | 2.78/ | 2.89/ |
| (10 GHz) | 0.00135 | 0.00074 | 0.00068 | 0.00071 | 0.00093 |
| Dk/Df ^{a)} | 2.80/ | 2.88/ | 2.87/ | 2.89/ | 2.92/ |
| (10 GHz) | 0.00259 | 0.00224 | 0.00273 | 0.00197 | 0.00179 |
| after 7 days | | | | | |
| storage at | | | | | |
| 85° C./85% | | | | | |
| Rel. | | | | | |
| Humidity | | | | | |
| T_{d2}/T_{d5}^{b)} | 346° C./ | 366° C./ | 378° C./ | 368° C./ | 383° C./ |
| | 382° C. | 382° C. | 388° C. | 388° C. | 393° C. |
| G′ onset^{c)} | Two | 278° C. | 313° C. | Two | Two |
| | onsets: | | | onsets: | onsets: |
| | 157° C./ | | | 146° C./ | 153° C./ |
| | 329° C. | | | 329° C. | 334° C. |

^{a)} SPDR at 10 GHz (25° C., 50% rel H)
^{b)}TGA, ranges from 25° C. to 800° C. at a rate of 10K/min under nitrogen (w/o silica)
^{c)}DMA ISO 6721, ranges from 25° C. to 300° C. at a rate of 5K/min (with 0.5% dicumyl peroxide)

### Preparation of Prepregs:

After all components identified in Table 1 were dissolved at room temperature in toluene, silica filler was added to produce a homogenous resin composition varnish with a concentration of 50-60% by weight solids. Glass fabric (E2116NE glass) was immersed into the varnish, then placed vertical in an oven and dried for 3 minutes at 150° C. to produce sheets of prepreg.

### Preparation of Laminates:

The sheets of prepreg above were press cured for 2 hours at 220° C. with a resin content of about 45% by weight to about 50% by weight in the final laminate.

### Comparative Example 6

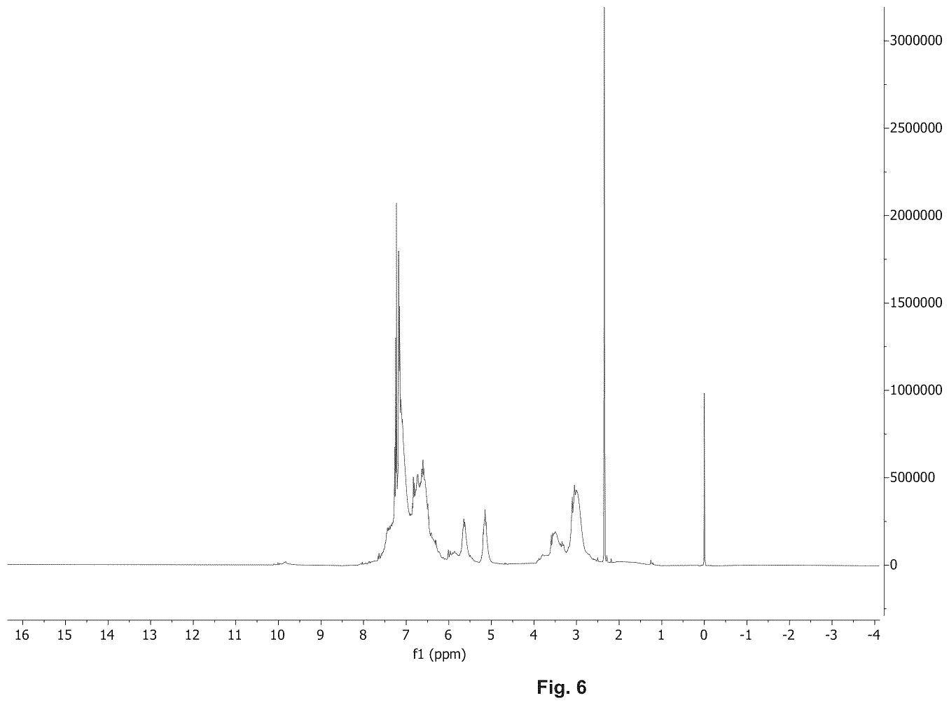

The same synthesis procedure as disclosed for example 1 has been carried out, except that 4,4′-bis(chloromethyl)biphenyl was replaced by an equimolar amount of α,α′-dichloro-p-xylene. Compound 6 (comparative example) was obtained as a yellow solid material in 87% yield and was identified from its 1H-NMR spectrum (FIG. 6) and GPC measurement. GPC indicated a weight average molecular weight Mw=2062 g/mol and a polydispersity of 2.5.

The compound was processed further (see table 3) as disclosed above and the results are illustrated in table 4 below.

TABLE 3

| Component | Comparative example 6 (pbw) |
|---|---|
| Compound 6 | 100 |
| Fused silica^{a)} | 25 |

^{a)}SC2300-SVJ (Admatechs)

TABLE 4

| Property | Comparative example 6 |
|---|---|
| Dk/Df ^{a)} (10 GHz) | 2.77/0.00179 |
| Dk/Df ^{a)} (10 GHz) after 7 days storage at | 2.77/0.00322 |
| 85° C./85% Rel. Humidity | |
| T_{d2}/T_{d5}^{b)} | 286° C./360° C. |
| G′ onset^{c)} | Two onsets: 130° C./329° C. |

^{a)} SPDR at 10 GHz (25° C., 50% rel. H)
^{b)}TGA, ranges from 25° C. to 800° C. at a rate of 10K/min under nitrogen (w/o silica)
^{c)}DMA ISO 6721, ranges from 25° C. to 300° C. at a rate of 5K/min (with 0.5% dicumyl peroxide)

1. A curable resin composition comprising at least
(1) A compound having the following formula C1: 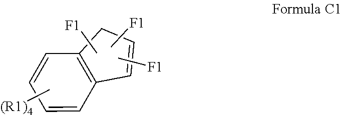
wherein each R1 is independently selected from a hydrogen atom, a halogen atom, an alkyl group having 1 to 5 carbon atoms, an alkoxy group having 1 to 5 carbon atoms, a thioalkoxy group having 1 to 5 carbon atoms, a thioaryloxy group having 6 to 14 carbon atoms, and an aryl group having 6 to 14 carbon atoms, and combinations thereof, and
each F1 is independently selected from a hydrogen atom and a vinylbenzyl group, and combinations thereof, provided that at least one of F1 is a vinylbenzyl group: 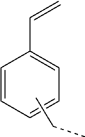
(2) A compound having the following formula C2: 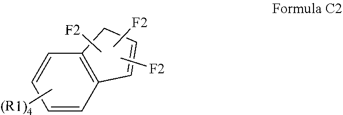
Wherein each R1 is independently selected from a hydrogen atom, a halogen atom, an alkyl group having 1 to 5 carbon atoms, an alkoxy group having 1 to 5 carbon atoms, a thioalkoxy group having 1 to 5 carbon atoms, a thioaryloxy group having 6 to 14 carbon atoms, and an aryl group having 6 to 14 carbon atoms, and combinations thereof, and
each F2 is independently selected from a hydrogen atom, a vinylbenzyl group 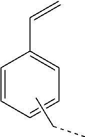
or a structure of the Formula F3, provided that at least one F2 is a structure of the formula F3: 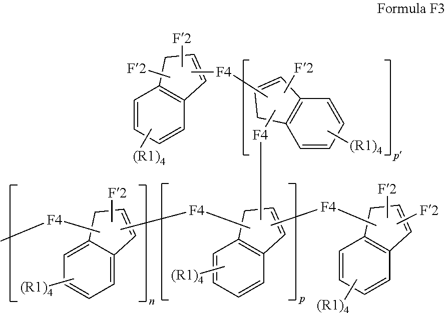
Wherein:
n, p and p′, independently, can range from 0 to 50, preferably from 0 to 10,
each R1 is independently selected from a hydrogen atom, a halogen atom, an alkyl group having 1 to 5 carbon atoms, an alkoxy group having 1 to 5 carbon atoms, a thioalkoxy group having 1 to 5 carbon atoms, a thioaryloxy group having 6 to 14 carbon atoms, and an aryl group having 6 to 14 carbon atoms, and combinations thereof,
each F′2 is independently selected from a hydrogen atom, a vinylbenzyl group, provided that at least one F2 or one F′2 is a vinylbenzyl group, 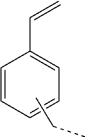
F4 is selected from divalent groups of the Formula F4, and combinations thereof: 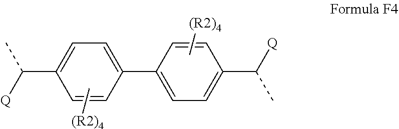
Wherein:
Each Q is independently selected from a hydrogen atom and a linear or branched C1-C6 alkyl group, or combinations thereof;
and
each R2 is independently selected from a hydrogen atom, a linear or branched C1-C6 alkyl group, a halogen atom, or combinations thereof.

2. Composition according to claim 1, wherein one or more of the following conditions is satisfied:
each Q is independently selected from H, CH3, and combinations thereof,
all R1 groups represent H,
all R2 groups represent H,
all R3 groups represent H.

3. Composition according to claim 1, further comprising one or more filler, preferably a silane treated filler, more preferably a silane treated amorphous silica.

4. Composition according to claim 3, wherein the one or more filler represents from 10 to 40% by weight, based on the total weight of the additivated resin composition.

5. A method for the preparation of a curable resin composition, comprising at least the steps of:
(i) mixing at least the compounds (a), (b), and (c), and
(ii) reacting said compounds in the presence of an alkali:
Wherein
Compound (a) is one or more indene compound represented by the following general formula 1: 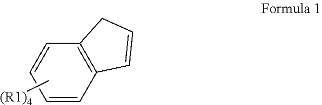
wherein each R1 is independently selected from a hydrogen atom, a halogen atom, an alkyl group having 1 to 5 carbon atoms, an alkoxy group having 1 to 5 carbon atoms, a thioalkoxy group having 1 to 5 carbon atoms, a thioaryloxy group having 6 to 14 carbon atoms, and an aryl group having 6 to 14 carbon atoms, and combinations thereof,
Compound (b) is one or more biphenyl compound represented by the following general Formula 2, 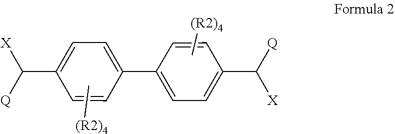
Wherein
Each X is independently selected from a halogen atom, a tosylate, a mesylate, a triflate, and combinations thereof,
Each Q is independently selected from a hydrogen atom and a linear or branched C1-C6 alkyl group, and combinations thereof,
and
Each R2 is independently selected from a hydrogen atom, a linear or branched C1-C6 alkyl group, a halogen atom, and combinations thereof,
Compound (c) is one or more vinylbenzyl compound represented by the following general Formula 3: 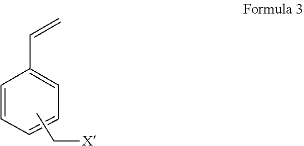
Wherein
X′ is selected from a halogen atom, a tosylate, a mesylate, a triflate and combinations thereof.

6. The method according to claim 5, wherein the molar ratio of all halomethyl, preferably chloromethyl, groups, if present, in compounds (b) and (c) to the reactive sites in compound (a) is 0.95 or lower.

7. The method according to claim 5, wherein the molar ratio of the indene compound (a) of Formula 1 to the biphenyl compound (b) of Formula 2 is in the range of 1.8/1 to 3/1.

8. The method according to any of claim 5, wherein the molar ratio of the indene compound (a) of Formula 1 to the vinylbenzyl compound (c) of Formula 3 is in the range of 1/1 to 1/2, preferably 1/1.75, most preferably 1/1.5.

9. The method according to any of claim 5, wherein one or more of the following conditions is satisfied:
each Q is independently selected from H, CH3, and combinations thereof,
all R1 groups represent H,
all R2 groups represent H,
all R3 groups represent H.

10. The method according to any of claim 5, wherein the vinylbenzyl compound represented by the general Formula 3 is selected from the group comprising 2-vinylbenzyl chloride, 3-vinylbenzyl chloride, 4-vinylbenzyl chloride, 2-vinylbenzyl bromide, 3-vinylbenzyl bromide, 4-vinylbenzyl bromide and mixtures thereof, preferably, the vinylbenzyl compound represented by the general Formula 3 is a mixture of 10-50% by weight of 2-vinylbenzyl chloride, 0-10% by weight of 3-vinylbenzyl chloride and 50-80% by weight of 4-vinylbenzyl chloride.

11. The method according to any of claim 5, wherein compound (b) is 4,4′-bis(chloromethyl)biphenyl.

12. The method according to any one of claim 5, wherein the method further comprises the addition of an onium-salts based catalyst selected from the list comprising tetra-n-butylammonium bromide, tetra-n-butylammonium chloride, tetra-n-butylammonium hydrogen sulfate, benzyltrimethylammonium chloride, and tricaprylmethylammonium chloride, tetra-n-butylphosphonium bromide, benzyltriphenylphosphonium chloride, tetraphenylphosphonium chloride, tetraphenylphosphonium bromide, benzyltetramethylene sulfonium bromide, and mixtures thereof.

13. The method according to any one of claim 5, wherein the method further comprises the addition of a radical inhibitor which is selected from the group consisting of quinones, phenols, catechols, phenothiazines, (2,2,6,6-tetramethylpiperidin-1-yl)oxyls, hydroxylamines and their corresponding salts, and mixtures thereof.

14. A curable resin composition obtainable, or obtained, by the method according to any one of claim 5.

15. A method for manufacturing an article, comprising at least the following steps:
Step 1:
Preparing a curable resin composition comprising at least a compound having the formula C1 and a compound having the formula C2 according to any one of claim 1, or Preparing a curable resin composition according claim 14,
said composition optionally comprising one or more additive,
Step 2:
Shaping the composition,
Step 3:
Curing the composition.

16. An article resulting from the implementation of the method of claim 15.

17. Article according to claim 16, having a dielectric dissipation factor (Df) measured on a Split Post Dielectric Resonator (SPDR) at a frequency of 10 GHz below 0.00100.

18. An article according to claim 16, which is a prepreg obtained by impregnating a fiber material with a composition according to any one of the claims 1 to 4 or 14.

19. A high-frequency laminate comprising the prepreg of claim 18 and a layer of an electrically conductive material disposed on at least one surface of the prepreg.

20. A printed wiring board produced by forming a conductive pattern on the surface of the laminated sheet of claim 19.
